(19) United States
(12) Patent Application Publication
(10) Pub. No.: US 2023/0009583 A1
(43) Pub. Date: Jan. 12, 2023

(54) EDGE CLEANING BY ROBOTIC CLEANING MACHINE

(71) Applicant: Nilfisk A/S, Broendby (DK)

(72) Inventors: Brian Wicks, Eden Prairie, MN (US); Andrew Graham, Maple Grove, MN (US)

(21) Appl. No.: 17/854,296

(22) Filed: Jun. 30, 2022

Related U.S. Application Data
(60) Provisional application No. 63/218,974, filed on Jul. 7, 2021.

(51) Int. Cl. A47L 11/40; G05D 1/02

(52) U.S. Cl. CPC A47L 11/4011; A47L 11/4069; A47L 11/4066; G05D 1/0223; G05D 1/0214; A47L 2201/06; A47L 2201/04; G05D 2201/0203

(57) ABSTRACT

A method of controlling the robotic floor cleaning machine is disclosed that includes sensing, by a sensor on the robotic cleaning machine, an object within a sensed field. The method further includes determining, by a safety controller on the robotic cleaning machine, whether the object is an immovable object (such as a wall), and deploying an extendable cleaning element to clean the floor surface up next to the wall. The method can further include deploying the extendable cleaning element such that the extendable cleaning element is in contact with and cleans the floor up to an edge of the immovable object. Additionally, the method can include determining that the object is a movable object (such as a living thing) and preventing the extendable cleaning element from extending such that the robotic cleaning machines does not contact the movable object.

### CROSS-REFERENCE TO RELATED APPLICATION(S)

This application claims the benefit of U.S. Provisional Application No. 63/218,974 filed Jul. 7, 2021 for “EDGE CLEANING BY ROBOTIC CLEANING MACHINE” by B. Wicks and A. Graham.

### TECHNICAL FIELD

The present patent application relates generally to a cleaning apparatus. More specifically, the present patent application relates, but not by way of limitation, to cleaning a floor surface adjacent a wall or another object by a robotic cleaning machine for autonomous floor cleaning.

### BACKGROUND

Industrial and commercial floors are cleaned on a regular basis for aesthetic and sanitary purposes. There are many types of industrial and commercial floors ranging from hard surfaces such as concrete, terrazzo, wood, and the like, which can be found in factories, schools, hospitals, and the like, to softer surfaces such as carpeted floors found in restaurants and offices. Different types of floor cleaning equipment such as scrubbers, sweepers, and extractors, have been developed to properly clean and maintain these different floor surfaces.

For example, a typical industrial or commercial scrubber is a walk-behind or drivable, self-propelled, wet process machine that applies a liquid cleaning solution from an onboard cleaning solution tank onto the floor through nozzles. Rotating brushes forming part of the scrubber agitate the solution to loosen dirt and grime adhering to the floor. The dirt and grime become suspended in the solution, which is collected by a vacuum squeegee fixed to a rearward portion of the scrubber and deposited into an onboard recovery tank.

Floor cleaning units can also be designed as unmanned, robotic units that operate autonomously. However, there are particular challenges in automating the cleaning process of an autonomous scrubber, particularly for large, industrial or commercial floor cleaning systems that can be employed unsupervised in areas where there is pedestrian traffic. One of those challenges is that, to meet industry safety standards, no part of the floor cleaning unit can come into contact with a test object during the certification process. However, it is advantageous for the floor cleaning unit to clean a floor surface all the way up next to a wall or another straight edge, which may not be accomplished without contacting the wall/edge.

### SUMMARY

The present invention recognizes, among other things, that a problem to be solved is meeting industry safety standards during the certification process while also cleaning an entire floor surface (i.e., a floor surface adjacent/up to an immovable object, such as a wall or other edge). During the certification process, the robotic cleaning machine must not contact the test object (e.g., a movable hollow cylinder placed in the cleaning path) but, during cleaning of the floor surface adjacent/up to an immovable object, the robotic cleaning machine may need to contact the immovable object to clean the floor surface next to the immovable object.

Thus, the present disclosure describes a solution to the problem and other problems by detailing a robotic cleaning machine with a deployable/extendable cleaning element, such as a scrubbing pad, broom, brush, spray nozzle, vacuum shoe, ultraviolent lamp, and squeegee. The robotic cleaning machine can determine whether objects in a sensed field (e.g., a field that maps the location of objects near the robotic cleaning machine) are walls/immovable objects or other, movable objects, such as toys or living things. If the object is determined to be an immovable object or if no objects are present in the sensed field, the robotic cleaning machine can deploy/extend an extendable cleaning element, which can clean the floor surface distant from and/or adjacent/up to the immovable object. The extendable cleaning surface can be configured to contact the immovable object. Once the robotic cleaning machine is no longer adjacent the immovable object, the extendable cleaning element can be retracted so as to not contact any moveable objects, or extendable cleaning element can remain deployed to aid in the continual cleaning of the floor surface. If the robotic cleaning machine determines that an object in the sensed field is a movable object and the robotic cleaning machine is near the movable object (or is moving in a path that would bring the extendable cleaning element into contact with the movable object), the extendable cleaning element is retracted so as to not contact the movable object.

In one example, a method of controlling the robotic floor cleaning machine is disclosed that includes sensing, by a sensor on the robotic cleaning machine, an object within a sensed field. The method further includes determining, by a safety controller on the robotic cleaning machine, whether the object is an immovable object (such as a wall or item of furniture), and, deploying an extendable cleaning element to clean the floor surface. The extendable cleaning element can be deployed when both no object is present in the sensed field and when an immovable object is present (i.e., when the robotic cleaning machine is adjacent the immovable object such that the extendable cleaning element is in contact with and cleans the floor surface up next to the immovable object). Additionally, the method can include determining that the object is a movable object (such as a living thing) and preventing the extendable cleaning element from extending such that the robotic cleaning machines does not contact the movable object.

In another example, a robotic floor cleaning machine is disclosed that includes a body with at least one extendable cleaning element, a sensor incorporated into the body for sensing a field around the body with the field including at least one object, and a safety controller that receives information relating to the field from the sensor and determines whether the at least one object is an immovable object. The safety controller allows the extendable cleaning element to deploy when the safety controller determines the at least one object is an immovable object. The robotic floor cleaning machine can be further configured such that the safety controller does not allow the extendable cleaning element to deploy when the safety controller determines that the object is a movable object. The robotic floor cleaning machine can further include an autonomy module that receives information from the safety controller that the immovable object is in the field and directs the robotic floor cleaning machine to move to be adjacent the immovable object so as to clean the floor surface up to the immovable object.

### BRIEF DESCRIPTION OF THE DRAWINGS

FIG. 1A is a perspective view of a robotic cleaning machine having a broom/brush in an extended position.

FIG. 1B is a perspective view of the robotic cleaning machine having the broom/brush in a retracted position.

FIG. 2A is a plan view of the robotic cleaning machine adjacent a wall.

FIG. 2B is a plan view of the robotic cleaning machine adjacent a test object.

FIG. 2C is a plan view of the robotic cleaning machine distant from the wall.

### DETAILED DESCRIPTION

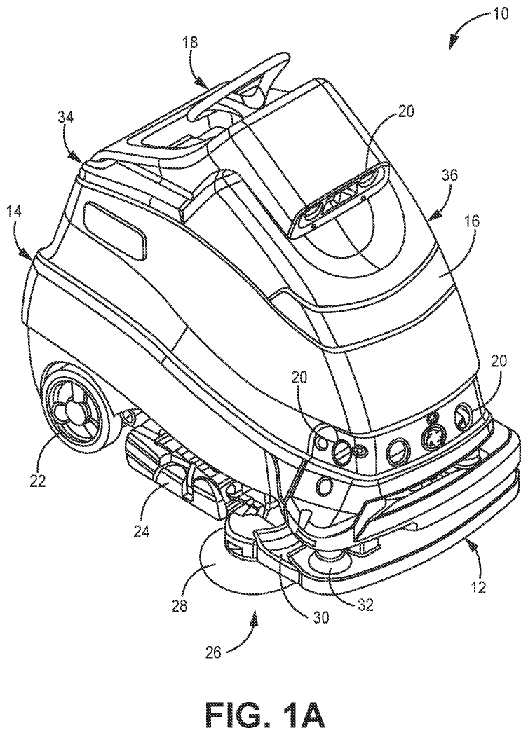

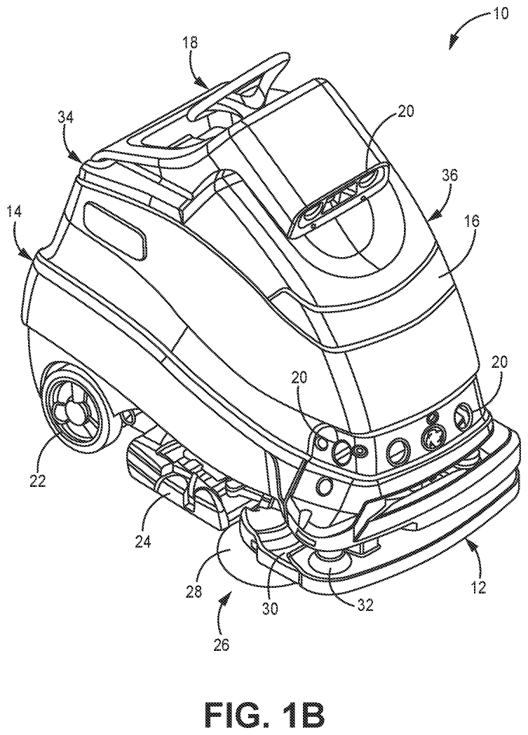

FIG. 1A is a perspective view of a robotic cleaning machine having a cleaning element in an extended position. FIG. 1B is a perspective view of the robotic cleaning machine having the cleaning element in a retracted position. As shown in FIGS. 1A and 1B, robotic cleaning machine 10 has front 12 and rear 14 and includes body 16, operator station 18, sensors 20, wheels 22 (only one wheel is shown but robotic cleaning machine 10 may include more than one wheel), cleaning deck 24, and extendable cleaning element 26. Extendable cleaning element 26 includes broom 28, movable arm 30, and pivot 32. Machine 10 further includes safety controller 34 and autonomy module 36, which can be onboard robotic cleaning machine 10 or remote from but in communication with machine 10. Movable arm 30 is shown in FIGS. 1A and 1B as having a housing to cover the internal components of movable arm 30, such as the structural arm. This disclosure will use the term “broom” to identify/describe any apparatus that can be utilized to clean a surface, such as a squeegee, scrubber, brush, mop, cloth, vacuum head, spray nozzle, ultraviolent lamp, or other cleaning element. Further, while described herein as cleaning deck 24, cleaning deck 24 can be any apparatus that can be configured and utilized by robotic cleaning machine 10 to clean a surface, such as a squeegee, brush, broom, mop, cloth, vacuum head, spray nozzle, ultraviolent lamp, or other cleaning element. Additionally, this disclosure will use the term “immovable object” to identify/describe any object around which machine 10 and cleaning element 26 can clean (e.g., clean the floor surface up to the immovable object while potentially having broom 28 come into contact with the immovable object). The immovable object can by an object that is not movable and/or damageable by the cleaning action of machine 10. Thus, the immovable object can be, for example, a wall, a curb, furniture, a door, a threshold for a door or at a seam in the floor, stairs, a window, or any other type of object/feature that is nonhorizontal with respect to the floor surface that machine 10 and extendable cleaning element 26 is intended to clean. This disclosure will use the term “movable object” to identify/describe any object that is movable and/or damageable if cleaning element 26 were to come into contact with the movable object. Thus, the movable object can be, for example, a living thing, a toy, clothing, or any other type of object/feature for which robotic cleaning machine 10 would need to retract cleaning element 26 to avoid damage or other issues.

Robotic cleaning machine 10 can be configured to clean, treat, scrub, sanitize, or polish a floor surface, or perform other similar actions using, for example, cleaning deck 24 and/or extendable cleaning element 26. An operator can stand at operator station 18 and control robotic cleaning machine 10. Alternatively, safety controller 34 and/or autonomy module 36, through the use of sensors 20 on/in body 16; which can be optical sensors, distance sensors, a lidar system, laser scanners, and/or personnel sensors; can allow machine 10 to autonomously drive itself. The present application describes various features that can be used to facilitate autonomous cleaning of a floor surface adjacent an immovable object by deploying extendable cleaning element 26. Extendable cleaning element 26 can be utilized to clean the floor surface up to the immovable object, which may not be accessible without the use of extendable cleaning element 26. The features described in the present application can be applied to any type of floor cleaning equipment, such as scrubbers, sweepers, and extractors, whether autonomous or user operated.

Robotic cleaning machine 10 can be configured to have numerous features not explicitly detailed in this disclosure, such as a platform for operator station 18 at rear 14 in which an operator can stand or sit and control robotic cleaning machine 10. Further, robotic cleaning machine 10 can have wireless connection capabilities to allow for the operator to control robotic cleaning machine 10 remotely and/or other features to allow robotic cleaning machine 10 to operate autonomously, such safety controller 34 and/or autonomy module 36 (which utilize sensors 20 in/on body 16) for analyzing and making decisions regarding the movement and operation of machine 10 (e.g., the deployment of extendable cleaning element 26).

Body 16 of robotic cleaning machine 10 provides structural support, a structure to which sensors 20 and other components can be attached and/or contained within, and a housing that protects inner components of machine 10. Body 16 can have any configuration and be constructed from various materials. In one example, body 16 is a plastic or composite material.

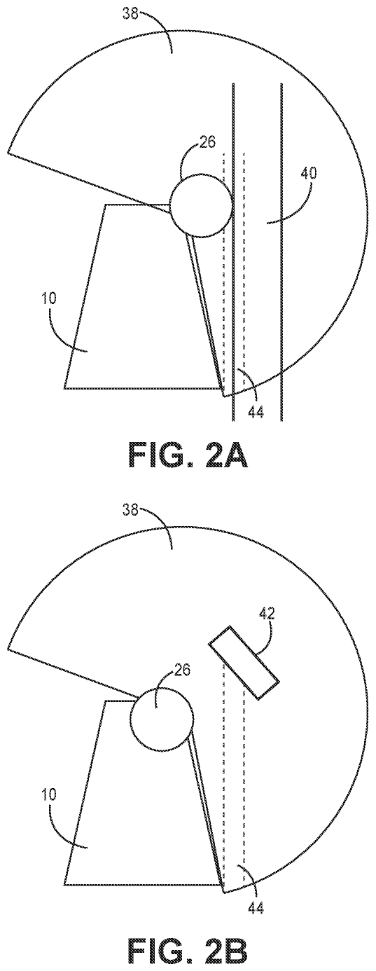

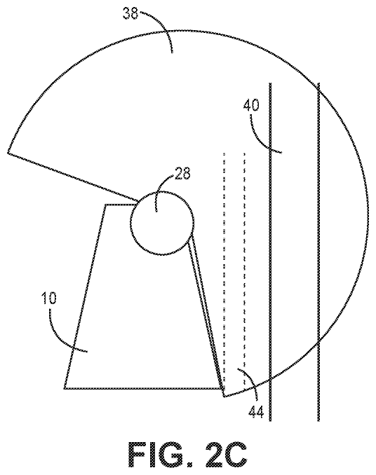

Robotic cleaning machine 10 can be of a three-wheel design having two wheels 22 generally behind the center of gravity of machine 10 (only one shown in FIGS. 1A and 1B) and one wheel 22 in front of the center of gravity (not shown in FIGS. 1A and 1B). In an example, operator station 18 can be located behind the center of gravity. Front wheel 22 can be both a steered wheel and a driven wheel. Front wheel 22 can have a device for determining the angular position of the driving direction about the steering axis. In an example, rear wheels 22 are not driven but have one or more devices, such as sensors 20, for determining speed of rotation of each wheel. The angular position of each wheel 22 and the angular position and steering angle of front wheel 22 can be used to determine the position of machine 10 relative to objects sensed by sensors 20 in mapping an environment surrounding robotic cleaning machine 10. The information collected by sensors 20 can be used by safety controller 34 and/or autonomy module 36 to map the environment surrounding robotic cleaning machine 10 by creating a sensed field (as is described with regards to FIGS. 2A-2C).

Cleaning deck 24 can be configured to provide a cleaning action to the floor, such as a rotary disc for orbital or cylindrical cleaning. Fluid from a liquid cleaning system disposed within body 16 can be dispensed by machine 10 to facilitate scrubbing performed by cleaning deck 24. A liquid system can include a liquid storage tank, a pump system, and spray nozzles. Cleaning deck 24 can be or can include a squeegee that can be used to corral or wipe dirty fluid behind cleaning deck 24 and can be connected to a recovery system having a tank disposed within body 16. A recovery system can include a suction tube, a suction motor, and a storage tank.

Robotic cleaning machine 10 can include one or numerous sensors 20, which can be an optical sensor, a distance sensor, a personnel sensor, an ambient light sensor, an ultrasonic sensor, a sonar sensor, a capacitance sensor, a wheel encoder, a dirt sensor, a debris sensor, an object recognition sensor, a floor type sensor, a surface recognition sensor, a vibration sensor, a cleaning media sensor, a squeegee sensor, a tank level sensor, a tank condition sensor, a moisture sensor, an optical interface sensor, a microwave sensor, an olfactory sensor, a stereo camera sensor, an infrared sensor, a wheel position sensor, a lidar system, and a laser scanner. Sensors 20 can be located in/on body 16 or other locations, such as remote from machine 10. As detailed below, sensors 20 are utilized by safety controller 34 to determine if/when to extend and retract extendable cleaning element 26 and by autonomy module 36 to determine where and in what manner to drive robotic cleaning machine 10.

As shown in FIGS. 1A and 1B, extendable cleaning element 26 is at front 12 of machine 10 on a bottom side. However, extendable cleaning element 26 can be located anywhere on machine 10, such as at rear 14. Extendable cleaning element 26 is configured to extend broom 28 to clean a floor surface that is laterally outside the area of cleaning deck 24, such as a floor surface adjacent an immovable object that cannot be reached by cleaning deck 24 (without machine 10 contacting the wall) as machine 10 drives near the immovable object due to cleaning deck 24 being located laterally inside a wheelbase of machine 10. Broom 28 can also be configured such that broom 28 is retracted when machine 10 is no longer next an immovable object (i.e., next to a floor surface in need of cleaning that would not otherwise be able to be reached by cleaning deck 24), or broom 28 can remain deployed when machine 10 is not next to an immovable object and only be retracted when machine 10 dives close to a movable object that could be moved or damaged by coming into contact with broom 28.

Broom 28 of extendable cleaning element 26 can be configured to provide a cleaning action to the floor, such as a rotary disc for orbital or cylindrical cleaning. Broom 28 can be a scrubber, a spray nozzle, a vacuum head, a squeegee, a brush an ultraviolent lamp, or another cleaning element suitable for cleaning a floor surface adjacent an immovable object. Broom 28 can have any size, location on/within machine 10, and/or configuration to allow for extendibility and retractability so as to be able to extend to clean next to an immovable object and retract so as to not contact a movable object, such as a test object during the certification process.

Movable arm 30 (shown as having a cover in FIGS. 1A and 1B) of extendable cleaning element 26 is attached to broom 28 at one end and pivots about pivot 32 to move broom 28 laterally from a retracted position within the wheelbase of robotic cleaning machine 10 (shown in FIG. 1B) to an extended/deployed position at least partially laterally outside the wheelbase of machine 10 (and laterally outside the cleaning width of cleaning deck 24; shown in FIG. 1A). Movable arm 30 can have any size, location, and/or configuration to be able to pivot about pivot 32 (or another pivot location) to move broom 28, including containing or being in communication with means for powering movable arm 30, such as an actuator. Movable arm 30 is in communication with safety controller 34 and/or autonomy module 36 to take direction as to whether to extend or retract broom 28.

Safety controller 34 can be a computer processor, and receives information from sensors 20 as to the location of objects around machine 10. Utilizing that information, safety controller 34 determines if one or multiple objects around machine 10 are immovable objects (around which movable arm 30 is allowed to deploy/extend into or remain in the deployed/extended position to allow broom 28 to clean the floor surface up to the immovable object when machine 10 is in position next to the immovable object) or are movable objects (around which movable arm 30 is prevented from deploying or is retracted to ensure broom 28 does not contact the movable object). Safety controller 34 maintains a safe environment around machine 10 by retracting (or keeping cleaning element 26 retracted) when machine 10 is near a movable object and allowing extendable cleaning element 26 to deploy/extend when machine 10 is not near movable object 42 and/or adjacent an immovable object to prevent extendable cleaning element 26 from contacting anything except an immovable object.

Autonomy module 36 can be a computer processor, and receives information from sensors 20 and/or safety controller 34 as to the location of machine 10 and objects around machine 10. Utilizing that information, autonomy module 36 can control the movement and operation of machine 10, such as driving machine 10 to be next to an immovable object to allow extendable cleaning element 26 (and cleaning deck 24) to clean a floor surface next/up to the immovable object. Autonomy module 36 can utilize the location of objects within the sensed field to optimize a cleaning route for machine 10 to clean the floor distant from and adjacent to objects. This can include adjusting a speed of machine 10 to be a safety constraining speed to prevent damage to machine 10, the immovable objects, or the movable objects. Additionally, autonomy module 36 can create a route to efficiently clean a floor area. While not detailed here, autonomy module 36 can control other aspects of machine 10, such as when cleaning deck 24 is in use and a maintenance schedule of machine 10.

Safety controller 34 and/or autonomy module 36 can be or include any one or more of a microprocessor, a controller, a digital signal processor (DSP), an application specific integrated circuit (ASIC), a field-programmable gate array (FPGA), or other equivalent discrete or integrated logic circuitry. Safety controller 34 and/or autonomy module 36 can be configured to store information during operation. Computer-readable memory, in some examples, is described as a computer-readable storage medium. In certain examples, a computer-readable storage medium can include a non-transitory medium. The term “non-transitory” can indicate that the storage medium is not embodied in a carrier wave or a propagated signal. In some examples, a non-transitory storage medium can store data that can, over time, change (e.g., in RAM or cache). Computer-readable memory can include volatile memory, non-volatile memory, or both. Examples of volatile memories can include random access memories (RAM), dynamic random access memories (DRAM), static random access memories (SRAM), and other forms of volatile memories. Examples of non-volatile memories can include flash memories, forms of electrically programmable memories (EPROM) or electrically erasable and programmable (EEPROM) memories, magnetic hard discs, optical discs, floppy discs, or other forms of non-volatile memories.

Safety controller 34 and/or autonomy module 36 can each be stand-alone components with one or multiple computer processors or can be incorporated into other machine 10 hardware and software systems. For example, safety controller 34 and autonomy module 36 can be separate components or incorporated into one software and/or hardware system. Additionally, safety controller 34 and/or autonomy module 36 can be located on/within machine 10 or can be remote from machine 10, such as within a cloud-based system with machine 10 in communication with safety controller 34 and/or autonomy module 36.

As detailed below with regards to FIGS. 2A-2C, sensors 20 collect information as to the location of machine 10 and objects around machine 10 and relay that information to safety controller 34 and/or autonomy module 36. Safety controller 34 determines if the environment adjacent robotic cleaning machine 10 is suitable for extendable cleaning element 26 to extend to clean a floor surface next to an immovable object, such as a wall, by comparing a sensed field (e.g., a map of the environment around machine 10) to a stored search pattern. If the comparison reveals that the sensed field contains an immovable object and machine 10 is adjacent that immovable object, safety controller 36 allows extendable cleaning element 26 to deploy/extend. Additionally, safety controller 34 can determine if any of the objects in the sensed field are movable objects by comparing the sensed field to a stored search pattern or by comparing the current sensed field to a previously recorded sensed field (which would show that the movable object is in a location that is different than a previously recorded sensed field). If the object is a movable object and machine 10 is driving near the moveable object, safety controller 36 does not allow cleaning element 26 to deploy or retracts cleaning element 26 if cleaning element was in the deployed position. Autonomy module 36 utilizes the sensed field to control the movement of robotic cleaning machine 10, such as driving machine 10 to be adjacent an immovable object so that extendable cleaning element 26 can clean the floor surface next to the immovable object.

Robotic cleaning machine 10 can be outfitted with a variety of different instruments, systems, sensors, and devices to enable and improve the autonomous operation of machine 10. Configurations of machine 10 can improve the efficiency of the cleaning or treating operation such as by reducing or eliminating deficient cleaning procedures and executing a consistent cleaning or treating operation, free of variability that can be introduced from procedure imperfections or operator error or variability. Furthermore, configurations of machine 10 can improve the efficiency and operation of navigation instructions provided to machine 10 to improve the safety, reliability, and cleaning or treating performance of machine 10.

FIG. 2A is a plan view of robotic cleaning machine 10 adjacent an immovable object, such as a wall. FIG. 2B is a plan view of robotic cleaning machine 10 adjacent a movable object, such as a test object. FIG. 2C is a plan view of robotic cleaning machine 10 distant from the immovable object (e.g., wall). While shown as wall 40 in FIGS. 2A and 2C, immovable object can be any type of immovable object as described above. Additionally, while shown as test object 42 in FIG. 2B, movable object can be any type of movable object as described above.

FIG. 2A shows robotic cleaning machine 10 with cleaning element 26 deployed/extended and adjacent wall 40, which is within sensed field 38. FIG. 2B shows robotic cleaning machine 10 with cleaning element 26 retracted and near test object 42, which is within sensed field 38. FIG. 2C shows robotic cleaning machine 10 with cleaning element 26 retracted and near (but not adjacent/next to) wall 40, which is within sensed field 38. FIGS. 2A-2C all show known search pattern 44, which is a pattern stored by safety controller 34 and/or autonomy module 36 to which sensed field 38 is compared to determine if wall 40 is within sensed field 38 and/or machine 10 is adjacent wall 40 such that extendable cleaning element 26 can be extended/deployed.

Sensors 20 on robotic cleaning machine 10, among other capabilities, collect information about the environment around machine 10 to form sensed field 38, which can be a map/representation of objects around machine 10, that is received by safety controller 34 (and/or autonomy module 36) and compared to known search pattern 44. Sensed field 38 can be as large or small of an area as desired in order to allow safety controller 34 and/or autonomy module 36 to determine if/when machine 10 and/or extendable cleaning element 26 should take action. Sensed field 38 can be formed through a variety of methods, including utilizing sensor 20 that includes a laser capable of scanning the environment to determine the location of nearby objects.

FIG. 2A shows sensed field 38 with wall 40 adjacent to machine 10. During this situation, safety controller 34 compares sensed field 38 (in which wall 40 is present and machine 10 is adjacent/next to wall 40) to known search pattern 44 to determine if wall 40 is indeed present and adjacent robotic cleaning machine 10. If so (as is the case in FIG. 2A), safety controller 34 allows extendable cleaning element 26 to extend to move broom 28 laterally outward to be able to clean the floor surface next to wall 40 (which may result in broom 28 contacting wall 40). The comparison of sensed field 38 to known search pattern 44 is continuous such that once the comparison shows that wall 40 is no longer adjacent robotic cleaning machine 10 in sensed field 38, safety controller 34 can retract extendable cleaning element 26 (e.g., instructs movable arm 30 to retract broom 28) so that broom 28 cannot contact any movable objects near machine 10. However, if no movable objects are near, safety controller 34 can allow cleaning element 26 to remain in the deployed/extended position to aid in cleaning the floor.

In one example, safety controller 34 can include a memory/storage medium that stores numerous known search patterns 44 that have configurations/footprints of immovable objects. These configurations are compared to sensed field 38 to determine if the object is an immovable object and where the immovable object is located relative to machine 10 so that machine 10 can clean an adjacent floor surface. In FIGS. 2A and 2C, wall 40 in sensed field 38 is matched to a footprint of a wall in known search pattern 44. As shown in FIG. 2C, wall 40 may not be next to/adjacent robotic cleaning machine 10. During this situation, a comparison of sensed field 38 to known search pattern 44 by safety controller 34 returns a determination that machine 10 is not adjacent wall 40. In FIG. 2C, cleaning element 26 is not deployed/extended, but other configurations/settings of machine 10 can have cleaning element 26 deployed at all times except when machine 10 is close to and/or approaching a movable object, such as in FIG. 2B. Comparing sensed field 38 to known search pattern 44 is just one example of how safety controller 34 determines that wall 40 is within sensed field 38. In another example, safety controller 34 analyses the size and shape of the objects within sensed field 38 and determines that the object is a wall if the object has a straight edge for a particular length of the object without a comparison to known search pattern 44.

Additionally, the location of immovable object/wall 40 can be relayed to autonomy module 36 (or determined by autonomy module 36 in a similar or different manner than the determination by safety controller 34), which utilizes this information to potentially guide the route of machine 10. For example, prior to the configuration shown in FIG. 2A, autonomy module 36 may have driven machine 10 to be next to wall 40 to clean the floor surface next to wall 40 (with machine 10 then driving/moving parallel to wall 40). Immovable object, such as wall 40, does not need to have a straight edge and can include curves, angles, or other configurations. Machine 10 along with extendable cleaning element 26 are configured to be able to drive along and clean the floor next to any shape of an immovable object.

FIG. 2B shows sensed field 38 with test object 42 near machine 10. During this situation, safety controller 34 compares sensed field 38 (in which an immovable object is not present but rather test object 42 is present) to known search pattern 44 to determine if the environment is suitable to allow extendable cleaning element 26 to extend broom 28 laterally outward. Because machine 10 is approaching and/or near a movable object (e.g., test object 42), safety controller 34 does not allow extendable cleaning element 26 to extend and extendable cleaning element 26 remains retracted (or, if previously deployed, retracts cleaning element 26 when machine 10 is no closer to the movable object than a distance cleaning element 26 extends away from machine 10 such that cleaning element 26 does not contact the movable object). Thus, extendable cleaning element 26 is prevented from contacting test object 42 and machine 10 passes the certification process. Autonomy module 36 can utilize the information regarding the size, location, and configuration of test object 42 to plan a route or otherwise drive around test object 42 to clean a floor near test object 42 without coming into contact with test object 42.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

### DISCUSSION OF POSSIBLE EMBODIMENTS

The following are non-exclusive descriptions of possible embodiments of the present invention.

The method of the preceding paragraph can optionally include, additionally and/or alternatively, any one or more of the following features, configurations, steps, and/or additional components:

The robotic floor cleaning machine of the preceding paragraph can optionally include, additionally and/or alternatively, any one or more of the following features, configurations, steps, and/or additional components:

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of controlling a robotic cleaning machine for cleaning a floor, the method comprising:
sensing, by a sensor on the robotic cleaning machine, a first object within a sensed field;
determining, by a safety controller, that the first object is an immovable object; and
deploying an extendable cleaning element to clean the floor.

2. The method of claim 1, wherein the extendable cleaning element is deployed such that the extendable cleaning element is in contact with and cleans the floor up to an edge of the immovable object.

3. The method of claim 1, further comprising:
driving the robotic cleaning machine along the immovable object such that the extendable cleaning element remains in contact with and cleans the floor along an edge of the immovable object.

4. The method of claim 1, further comprising:
sensing, by the sensor, the first object within the sensed field at regular intervals; and
retracting the extendable cleaning element when the safety controller determines that the robotic cleaning machine is no longer adjacent the first object.

5. The method of claim 1, wherein the immovable object is one of a wall, a door, and a curb.

6. The method of claim 1, wherein the extendable cleaning element includes one of a scrubbing pad, a spray nozzle, a vacuum head, an ultraviolent lamp, and a squeegee.

7. The method of claim 1, further comprising:
sensing, by the sensor, a second object within a sensed field;
determining, by the safety controller, that the second object is a movable object; and
preventing the extendable cleaning element from extending such that the robotic cleaning machine does not contact the movable object.

8. The method of claim 7, further comprising:
retracting the extendable cleaning element when the robotic cleaning machine is no closer to the movable object than a distance the extendable cleaning element extends away from a body of the robotic cleaning machine such that the extendable cleaning element does not contact the movable object.

9. The method of claim 1, further comprising:
sensing that no movable object is within the sensed field; and
either deploying the extendable cleaning element if the extendable cleaning element is in a retracted position or continuing to deploy the extendable cleaning element if the extendable cleaning element is in a deployed position.

10. The method of claim 1, wherein the step of determining that the first object is an immovable object further comprises:
comparing the sensed field with a known search pattern that includes a footprint of a similarly configured immovable object.

11. The method of claim 10, wherein the comparison between the sensed field and the known search pattern is performed by the safety controller.

12. The method of claim 10, wherein the known search pattern is stored in a memory of the safety controller.

13. The method of claim 10, further comprising:
preventing the extendable cleaning element from deploying if the sensed field does not match the sensed field to the known search pattern that includes the footprint of a similarly configured immovable object.

14. The method of claim 1, further comprising:
optimizing a cleaning route for the robotic floor cleaning machine to clean the floor up to an edge of the immovable object; and
cleaning the floor along the immovable object up to the edge of the immovable object.

15. The method of claim 14, further comprising:
adjusting, by an autonomy module, a speed of the robotic cleaning machine to be a safety constraining speed when the robotic cleaning machine is adjacent the immovable object.

16. A robotic floor cleaning machine comprising:
a body that includes at least one extendable cleaning element;
a sensor incorporated into the body operable for sensing a field around the body, the field including at least one object; and
a safety controller that receives information relating to the field from the sensor and determines whether the at least one object is an immovable object, and
wherein the safety controller allows the extendable cleaning element to deploy when the safety controller determines the at least one object is an immovable object.

17. The robotic floor cleaning machine of claim 16, wherein the safety controller does not allow the extendable cleaning element to deploy or retracts the extendable cleaning element when the safety controller determines the at least one object is a movable object.

18. The robotic floor cleaning machine of claim 16, wherein the safety controller allows the extendable cleaning element to deploy when the safety controller determines that no movable object is within the field.

19. The robotic floor cleaning machine of claim 16, further comprising:
an autonomy module that receives information from the safety controller that the immovable object is in the field and directs the robotic floor cleaning machine to move so as to be close enough to the immovable object such that the extendable cleaning element in a deployed position is in contact with and cleans the floor up to an edge of the immovable object.

20. The robotic floor cleaning machine of claim 16, wherein the sensor is at least one of an optical sensor, a distance sensor, a personnel sensor, an ambient light sensor, an ultrasonic sensor, a sonar sensor, a capacitance sensor, a lidar system, a wheel encoder, a dirt sensor, a debris sensor, an object recognition sensor, a floor type sensor, a surface recognition sensor, a vibration sensor, a cleaning media sensor, a squeegee sensor, a tank level sensor, a tank condition sensor, a moisture sensor, an optical interface sensor, a microwave sensor, an olfactory sensor, a stereo camera sensor, an infrared sensor, a wheel position sensor, and a laser scanner.
